(19) United States
(12) Patent Application Publication
(10) Pub. No.: US 2024/0327288 A1
(43) Pub. Date: Oct. 3, 2024

(54) GYPSUM PLASTER BOARD WITH BIOCHAR

(71) Applicant: CERTAINTEED GYPSUM, INC., Malvern, PA (US)

(72) Inventors: Remi LESPIAT, Devon, PA (US); Agathe Dujardin, Bryn Mawr, PA (US); Joseph Kelleher, Philadelphia, PA (US)

(21) Appl. No.: 18/619,598

(22) Filed: Mar. 28, 2024

Related U.S. Application Data
(60) Provisional application No. 63/493,476, filed on Mar. 31, 2023.

(51) Int. Cl. C04B 28/14; C04B 18/10; C04B 24/16; C04B 38/10; C04B 103/40; C04B 103/42; C04B 111/00

(52) U.S. Cl. CPC C04B 28/14; C04B 18/10; C04B 24/16; C04B 38/10; C04B 2103/402; C04B 2103/42; C04B 2111/0062

(57) ABSTRACT

According to one aspect, a plaster based construction material can include a gypsum based plaster, and at least 1 part by weight biochar per 100 parts by weight gypsum. The construction material can have a nail pull force according to ASTM C1396 of at least 51 lbf or a core hardness according to ASTM C473 Method B of at least 66 N.

According to another aspect, a plaster based construction material can include a gypsum based plaster, at least 1 part by weight bichar per 100 parts by weight gypsum, and a stable or unstable surfactant. The plaster based construction material may have a relatively improved mechanical strength.

### CROSS-REFERENCE TO RELATED APPLICATION(S)

This application claims priority under 35 U.S.C. § 119 (e) to U.S. Provisional Application No. 63/493,476, entitled “GYPSUM PLASTER BOARD WITH BIOCHAR,” by Remi LESPIAT et al., filed Mar. 31, 2023, which is assigned to the current assignee hereof and incorporated herein by reference in its entirety.

### FIELD OF THE DISCLOSURE

The following is directed to plaster based construction materials, and particularly, plaster based construction materials containing biochar.

### BACKGROUND

Gypsum building products (e.g., known variously as wallboard, ceiling board, plasterboard and “drywall”) are panels made of a gypsum core sandwiched between two layers of liner, often paper, on the outside surfaces of the gypsum core. They are widely used as construction materials due to their case of fabrication, high mechanical strength, low thermal conductivity, resistance to spread of fire, and soundproofing properties. The quality of a gypsum board is strongly dependent on its gypsum core, which is fabricated by the hydration of stucco slurry (mainly containing calcium sulfate hemihydrate) into a set body of calcium sulfate dihydrate. To control the properties of gypsum boards, additives are often added to the stucco slurry during the board making process. For example, foaming agents, inorganic compounds, and other additives may be included in the slurry to modulate the density, strength, and/or fire resistance properties of the board.

Glass fibers can be included to reinforce gypsum boards. The glass fibers can include a coating or sizing. Different glass fibers interface differently with gypsum compositions. There is a need in the art to find methods and compositions that allow for improved glass fiber-gypsum interfaces.

### SUMMARY

According to one aspect a plaster based construction material can include a gypsum based plaster, and at least 1 part by weight biochar per 100 parts by weight gypsum. The construction material can have a nail pull force according to ASTM C1396 of at least 51 lbf or a core hardness according to ASTM C473 Method B of at least 66 N.

According to another aspect, a plaster based construction material can include a gypsum based plaster, at least 1 part by weight bichar per 100 parts by weight gypsum, and a stable or unstable surfactant. The plaster based construction material may have a relatively improved mechanical strength.

The construction materials may also have a particular pore size.

### BRIEF DESCRIPTION OF THE DRAWINGS

The present disclosure may be better understood, and its numerous features and advantages made apparent to those skilled in the art by referencing the accompanying drawings.

FIG. 1 includes a process for forming a plaster based construction material.

FIGS. 2a and 2b include images of exemplary plaster based construction material cross sections.

FIG. 3 includes a plot of a biochar particle size distribution.

### DETAILED DESCRIPTION

The following is directed to plaster based construction materials including biochar. Biochar is a pyrogenic solid created when a biomass feed undergoes pyrolysis. Biochar production and storage is an effective means of sequestering carbon in a more permanent form as compared to the biomass feed, lowering the rate at which photosynthetically fixed carbon is returned to the atmosphere. Accordingly, biochar storage, within plaster materials or otherwise, can be a means of mitigating the effects of climate change.

Plaster boards, also known as “drywall boards,” are typically used to construct walls within homes, businesses, or other buildings. Plaster boards are very often made of gypsum, but other materials, including lime and cement, are also used. The plaster board may be cut into sections having predetermined lengths and widths that conform to accepted construction standards. Drywall is available in four common thicknesses: ¼″, ⅜″, ½″ and ⅝″. Boards can also be 1″ thick. The most commonly used thickness is ½″, which forms the walls and ceilings of the majority of residential construction in the US. The ¼″ and ⅜″ sizes are typically used to cover existing drywall or in areas that require curved walls, and are not used in areas that require strong panels, such as ceilings. ⅝″ drywall is normally used in applications where increased fire resistance is desired, or where increased panel strength is a necessity like in high traffic institutional buildings. The standard sheet size for drywall is 4′×8′. However, the ½″ and ⅝″ thicknesses, though remaining at a width of 4′, are also available in lengths of 9, 10, 12, 14, and 16 feet. Of course, custom sizes are also available.

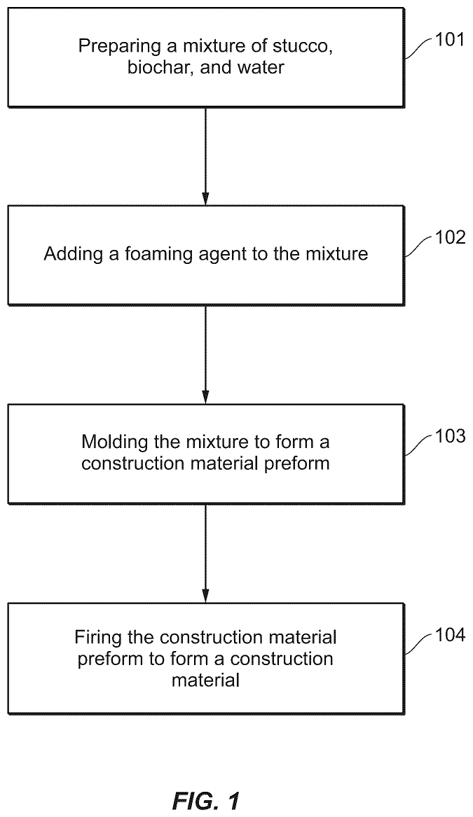

FIG. 1 includes a process for forming a plaster based construction material including biochar. Step 101 may include preparing a mixture of stucco, biochar, and water. Step 102 may include adding a foaming agent to the mixture. Step 103 may include molding the mixture to form a construction material preform. Step 104 may include firing the construction material preform to form a construction material.

In an embodiment, the mixture may include a stucco, water, and biochar. The stucco can be gypsum based stucco.

In an embodiment, the mixture may contain a particular water content that may facilitate improved performance and/or manufacturing of the construction material. In an embodiment, the mixture may include at least 40 parts by weight water per 100 parts stucco or at least 42 parts water or at least 44 parts water or at least 46 parts water or at least 48 parts water or at least 50 parts water. In an embodiment, the mixture may include less than 80 parts water per 100 parts stucco or less than 78 parts water or less than 76 parts water or less than 74 parts water or less than 72 parts water or less than 70 parts water or less than 68 parts water or less than 66 parts water or less than 64 parts water or less than 62 parts water or less than 60 parts water. It will be appreciated that the water content may be within a range between any of the minimum and maximum values noted above. It will be further appreciated that the water content may be any value between any of the minimum and maximum values noted above.

In an embodiment, the mixture may contain a particular biochar content that may facilitate improved performance and/or manufacturing of the construction material. In an embodiment, the mixture may include at least 1 parts biochar by weight per 100 parts by weight stucco or at least 1.5 parts biochar or at least 2 parts biochar or at least 2.5 parts biochar or at least 3 parts biochar or at least 3.5 parts biochar or at least 4 parts biochar or at least 4.5 parts biochar or at least 5 parts biochar. In an embodiment, the mixture may include less than 50 parts biochar per 100 parts by weight stucco or less than 45 parts biochar or less than 40 parts biochar or less than 35 parts biochar or less than 30 parts biochar or less than 25 parts biochar or less than 20 parts biochar or less than 15 parts biochar. It will be appreciated that the biochar content may be within a range between any of the minimum and maximum values noted above. It will be further appreciated that the biochar content may be any value between any of the minimum and maximum values noted above.

In an embodiment, the biochar can be prepared from a particular feedstock that may facilitate improved performance and/or manufacturing of the construction material. In an embodiment, the biochar can be prepared from biomass including wood, straw, grass, bagasse, bamboo, herbaceous material, maize, manure, paper sludge, pits, shells, stones, rice and rice residue, sewage, wheat, or any combination thereof.

In an embodiment, the biochar can undergo pyrolysis at a particular temperature that may facilitate improved performance and/or manufacturing of the construction material. In an embodiment, the biochar can be prepared via a pyrolysis process of at least 300° C. or at least 325° C. or at least 350° C. or at least 375° C. or at least 400° C. or at least 425° C. or at least 450° C. or at least 475° C. or at least 500° C. or at least 525° C. or at least 550° C. or at least 575° C. or at least 600° C. or at least 625° C. or at least 650° C. or at least 675° C. In an embodiment, the biochar can be prepared via a pyrolysis process of less than 725° C. or less than 700° C. or less than 675° C. or less than 650° C. or less than 625° C. or less than 600° C. or less than 575° C. or less than 550° C. or less than 525° C. or less than 500° C. or less than 475° C. or less than 450° C. or less than 425° C. or less than 400° C. or less than 375° C. It will be appreciated that the pyrolysis temperature may be within a range between any of the minimum and maximum values noted above. It will be further appreciated that the pyrolysis temperature may be any value between any of the minimum and maximum values noted above.

In an embodiment, the mixture may contain a reinforcer. The reinforcer may have a particular composition that may facilitate improved performance and/or manufacturing of the construction material. In an embodiment, the reinforcer can include polymer fibers, mineral fibers, glass fibers, animal fibers, vegetable fibers, or any combination thereof. In an embodiment, the reinforcer can include glass fibers.

In an embodiment, the mixture may contain a particular reinforcer content that may facilitate improved performance and/or manufacturing of the construction material. In an embodiment, the mixture may include at least 0.03 parts reinforcer per 100 parts stucco or at least 0.05 parts reinforcer or at least 0.1 part reinforcer or at least 0.2 parts reinforcer or at least 0.3 parts reinforcer or at least 0.4 parts reinforcer or at least 0.5 parts reinforcer or at least 0.6 parts reinforcer or at least 0.7 parts reinforcer or at least 0.8 parts reinforcer or at least 0.9 parts reinforcer. In an embodiment, the mixture may include less than 20 parts reinforcer per 100 parts stucco or less than 19 parts reinforcer or less than 18 parts reinforcer or less than 17 parts reinforcer or less than 16 parts reinforcer or less than 15 parts reinforcer or less than 14 parts reinforcer or less than 13 parts reinforcer or less than 12 parts reinforcer or less than 11 parts reinforcer or less than 10 parts reinforcer or less than 9 parts reinforcer or less than 8 parts reinforcer or less than 7 parts reinforcer or less than 6 parts reinforcer or less than 5 parts reinforcer. It will be appreciated that the reinforcer content may be within a range between any of the minimum and maximum values noted above. It will be further appreciated that the reinforcer content may be any value between any of the minimum and maximum values noted above.

In an embodiment, the mixture may contain a starch. The starch may have a particular composition that may facilitate improved performance and/or manufacturing of the construction material. In an embodiment, the starch can be pregelatinized starch. In an embodiment, the starch may be pretreated with an acid. In an embodiment, the starch may be a dextrin or vegetable flour. In an embodiment, the starch may be wheat flour or a corn flour.

In an embodiment, the mixture may contain a particular starch content that may facilitate improved performance and/or manufacturing of the construction material. In an embodiment, the mixture may include at least 0.001 part starch per 100 parts stucco or at least 0.01 parts starch or at least 0.1 parts starch or at least 0.2 parts starch or at least 0.3 parts starch or at least 0.4 parts starch or at least 0.5 parts starch or at least 0.6 parts starch or at least 0.7 parts starch or at least 0.8 parts starch or at least 0.9 parts starch. In an embodiment, the mixture may include less than 20 parts starch per 100 parts stucco or less than 19 parts starch or less than 18 parts starch or less than 17 parts starch or less than 16 parts starch or less than 15 parts starch or less than 14 parts starch or less than 13 parts starch or less than 12 parts starch or less than 11 parts starch or less than 10 parts starch or less than 9 parts starch or less than 8 parts starch or less than 7 parts starch or less than 6 parts starch or less than 5 parts starch or less than 4 parts starch or less than 3 parts starch or less than 2 parts starch or less than 1 part starch. It will be appreciated that the starch content may be within a range between any of the minimum and maximum values noted above. It will be further appreciated that the starch content may be any value between any of the minimum and maximum values noted above.

In an embodiment, the mixture may contain an accelerator. The accelerator may have a particular composition that may facilitate improved performance and/or manufacturing of the construction material. In an embodiment, the accelerator can be a ball milled accelerator. In an embodiment, the accelerator can include ground gypsum.

In an embodiment, the mixture may contain a particular accelerator content that may facilitate improved performance and/or manufacturing of the construction material. In an embodiment, the mixture may include at least 0.1 part accelerator per 100 parts stucco or at least 0.2 parts accelerator or at least 0.3 parts accelerator or at least 0.4 parts accelerator or at least 0.5 parts accelerator or at least 0.6 parts accelerator or at least 0.7 parts accelerator or at least 0.8 parts accelerator or at least 0.9 parts accelerator. In an embodiment, the mixture may include less than 20 parts accelerator per 100 parts stucco or less than 19 parts accelerator or less than 18 parts accelerator or less than 17 parts accelerator or less than 16 parts accelerator or less than 15 parts accelerator or less than 14 parts accelerator or less than 13 parts accelerator or less than 12 parts accelerator or less than 11 parts accelerator or less than 10 parts accelerator or less than 9 parts accelerator or less than 8 parts accelerator or less than 7 parts accelerator or less than 6 parts accelerator or less than 5 parts accelerator. It will be appreciated that the accelerator content may be within a range between any of the minimum and maximum values noted above. It will be further appreciated that the accelerator content may be any value between any of the minimum and maximum values noted above.

In an embodiment, the mixture may contain a fire retardant. The fire retardant may have a particular composition that may facilitate improved performance and/or manufacturing of the construction material. In an embodiment, the fire retardant can include vermiculite, silica, clay, metal fibers, mineral fibers, glass fibers, perlite, expandable graphite, or any combination thereof.

In an embodiment, the mixture may contain a particular fire retardant content that may facilitate improved performance and/or manufacturing of the construction material. In an embodiment, the mixture may include at least 0.1 part fire retardant per 100 parts stucco or at least 0.2 parts fire retardant or at least 0.3 parts fire retardant or at least 0.4 parts fire retardant or at least 0.5 parts fire retardant or at least 0.6 parts fire retardant or at least 0.7 parts fire retardant or at least 0.8 parts fire retardant or at least 0.9 parts fire retardant. In an embodiment, the mixture may include less than 20 parts fire retardant per 100 parts stucco or less than 19 parts fire retardant or less than 18 parts fire retardant or less than 17 parts fire retardant or less than 16 parts fire retardant or less than 15 parts fire retardant or less than 14 parts fire retardant or less than 13 parts fire retardant or less than 12 parts fire retardant or less than 11 parts fire retardant or less than 10 parts fire retardant or less than 9 parts fire retardant or less than 8 parts fire retardant or less than 7 parts fire retardant or less than 6 parts fire retardant or less than 5 parts fire retardant. It will be appreciated that the fire retardant content may be within a range between any of the minimum and maximum values noted above. It will be further appreciated that the fire retardant content may be any value between any of the minimum and maximum values noted above.

In an embodiment, the mixture may contain water repellant. The water repellant may have a particular composition that may facilitate improved performance and/or manufacturing of the construction material. In an embodiment, the water repellant can include a siloxane or a polysiloxane.

In an embodiment, the mixture may contain a particular water repellant content that may facilitate improved performance and/or manufacturing of the construction material. In an embodiment, the mixture may include at least 0.1 part water repellant per 100 parts stucco or at least 0.2 parts water repellant or at least 0.3 parts water repellant or at least 0.4 parts water repellant or at least 0.5 parts water repellant or at least 0.6 parts water repellant or at least 0.7 parts water repellant or at least 0.8 parts water repellant or at least 0.9 parts water repellant. In an embodiment, the mixture may include less than 20 parts water repellant per 100 parts stucco or less than 19 parts water repellant or less than 18 parts water repellant or less than 17 parts water repellant or less than 16 parts water repellant or less than 15 parts water repellant or less than 14 parts water repellant or less than 13 parts water repellant or less than 12 parts water repellant or less than 11 parts water repellant or less than 10 parts water repellant or less than 9 parts water repellant or less than 8 parts water repellant or less than 7 parts water repellant or less than 6 parts water repellant or less than 5 parts water repellant. It will be appreciated that the water repellant content may be within a range between any of the minimum and maximum values noted above. It will be further appreciated that the water repellant content may be any value between any of the minimum and maximum values noted above.

In an embodiment, the mixture may contain a biocide. The biocide may have a particular composition that may facilitate improved performance and/or manufacturing of the construction material. In an embodiment, the biocide can include sodium omadine, a pyrithione, a pyrithione complex, or any combination thereof. In a particular embodiment, the biocide may include a pyrithione or pyrithione complex including ions selected from the group consisting of sodium, zinc, silver, copper, and any combination thereof.

In an embodiment, the mixture may contain a particular biocide content that may facilitate improved performance and/or manufacturing of the construction material. In an embodiment, the mixture may include at least 0.1 part biocide per 100 parts stucco or at least 0.2 parts biocide or at least 0.3 parts biocide or at least 0.4 parts biocide or at least 0.5 parts biocide or at least 0.6 parts biocide or at least 0.7 parts biocide or at least 0.8 parts biocide or at least 0.9 parts biocide. In an embodiment, the mixture may include less than 20 parts biocide per 100 parts stucco or less than 19 parts biocide or less than 18 parts biocide or less than 17 parts biocide or less than 16 parts biocide or less than 15 parts biocide or less than 14 parts biocide or less than 13 parts biocide or less than 12 parts biocide or less than 11 parts biocide or less than 10 parts biocide or less than 9 parts biocide or less than 8 parts biocide or less than 7 parts biocide or less than 6 parts biocide or less than 5 parts biocide. It will be appreciated that the biocide content may be within a range between any of the minimum and maximum values noted above. It will be further appreciated that the biocide content may be any value between any of the minimum and maximum values noted above.

In an embodiment, the mixture may contain a fluidizing agent. The fluidizing agent may have a particular composition that may facilitate improved performance and/or manufacturing of the construction material. In an embodiment, the fluidizing agent may be a polycarboxylate ether, a polyphosphonate polyoxyalkylene, or any combination thereof. The mixture may have a particular content of fluidizing agent that may facilitate improved performance and/or manufacturing of the construction material. In an embodiment, the mixture can include less than 1 part fluidizing agent per 100 parts stucco.

In an embodiment, the mixture may contain a retardant. The retardant may have a particular composition that may facilitate improved performance and/or manufacturing of the construction material. In an embodiment, the retardant may be citric acid and its salts, tartaric acid, sodium polyphosphate, and calcium acetate, or any combination thereof. The mixture may have a particular content of retardant that may facilitate improved performance and/or manufacturing of the construction material. In an embodiment, the mixture can include less than 1 part retardant per 100 parts stucco.

Returning to FIG. 1, step 102 may include adding a foaming agent to the mixture. In an embodiment, the foaming agent may have a particular composition that may facilitate improved performance and/or manufacturing of the construction material. In an embodiment, the foaming agent can be an alkyl ether sulfate blend or an ammonium salt of a sulfated linear alcohol ethoxylate. In an embodiment, the foaming agent can be an ammonium salt of a sulfated linear alcohol ethoxylate. In an embodiment, the foaming agent can be sodium lauryl sulfate.

In an embodiment, the mixture may contain a particular foaming agent content that may facilitate improved performance and/or manufacturing of the construction material. In an embodiment, the mixture may include at least 0.0001 parts foaming agent per 100 parts stucco or at least 0.0002 parts foaming agent or at least 0.0003 parts foaming agent or at least 0.0004 parts foaming agent or at least 0.0005 parts foaming agent or at least 0.0006 parts foaming agent or at least 0.0007 parts foaming agent or at least 0.0008 parts foaming agent or at least 0.0009 parts foaming agent. In an embodiment, the mixture may include less than 1 part foaming agent per 100 parts stucco. It will be appreciated that the foaming agent content may be within a range between any of the minimum and maximum values noted above. It will be further appreciated that the foaming agent content may be any value between any of the minimum and maximum values noted above.

Returning to FIG. 1, step 103 may include molding the mixture to form a construction material preform.

Returning to FIG. 1, step 104 may include firing the construction material preform to form a construction material. In an embodiment, the preform can be fired until the preform is essentially free of water.

In an embodiment, the final construction material can be a plaster construction material. The construction material may include a gypsum plaster material and biochar.

In an embodiment, the construction material may contain a particular biochar content that may facilitate improved performance and/or manufacturing of the construction material. In an embodiment, the construction material may include at least 1 parts biochar by weight per 100 parts by weight gypsum or at least 1.5 parts biochar or at least 2 parts biochar or at least 2.5 parts biochar or at least 3 parts biochar or at least 3.5 parts biochar or at least 4 parts biochar or at least 4.5 parts biochar or at least 5 parts biochar. In an embodiment, the construction material may include less than 50 parts biochar per 100 parts by weight gypsum or less than 45 parts biochar or less than 40 parts biochar or less than 35 parts biochar or less than 30 parts biochar or less than 25 parts biochar or less than 20 parts biochar or less than 15 parts biochar. It will be appreciated that the biochar content may be within a range between any of the minimum and maximum values noted above. It will be further appreciated that the biochar content may be any value between any of the minimum and maximum values noted above.

In an embodiment, the biochar may have a particular average particle size that may facilitate improved performance and/or manufacturing of the construction material. In an embodiment, the biochar can have an average size of at least 1 micron or at least 5 microns or at least 10 microns or at least 25 microns or at least 50 microns or at least 100 microns or at least 200 microns or at least 500 microns. In an embodiment, the biochar can have an average size of less than 5 mm or less than 4 mm or less than 3 mm or less than 2 mm or less than 1 mm. It will be appreciated that the biochar size may be within a range between any of the minimum and maximum values noted above. It will be further appreciated that the biochar size may be any value between any of the minimum and maximum values noted above.

In an embodiment, the construction material may contain a reinforcer. The reinforcer may have a particular composition that may facilitate improved performance and/or manufacturing of the construction material. In an embodiment, the reinforcer can include polymer fibers, mineral fibers, glass fibers, animal fibers, vegetable fibers, or any combination thereof. In an embodiment, the reinforcer can include glass fibers.

In an embodiment, the construction material may contain a particular reinforcer content that may facilitate improved performance and/or manufacturing of the construction material. In an embodiment, the construction material may include at least 0.03 parts reinforcer per 100 parts gypsum or at least 0.05 part reinforcer or at least 0.01 part reinforcer or at least 0.2 parts reinforcer or at least 0.3 parts reinforcer or at least 0.4 parts reinforcer or at least 0.5 parts reinforcer or at least 0.6 parts reinforcer or at least 0.7 parts reinforcer or at least 0.8 parts reinforcer or at least 0.9 parts reinforcer. In an embodiment, the construction material may include less than 20 parts reinforcer per 100 parts gypsum or less than 19 parts reinforcer or less than 18 parts reinforcer or less than 17 parts reinforcer or less than 16 parts reinforcer or less than 15 parts reinforcer or less than 14 parts reinforcer or less than 13 parts reinforcer or less than 12 parts reinforcer or less than 11 parts reinforcer or less than 10 parts reinforcer or less than 9 parts reinforcer or less than 8 parts reinforcer or less than 7 parts reinforcer or less than 6 parts reinforcer or less than 5 parts reinforcer. It will be appreciated that the reinforcer content may be within a range between any of the minimum and maximum values noted above. It will be further appreciated that the reinforcer content may be any value between any of the minimum and maximum values noted above.

In an embodiment, the construction material may contain a starch. The starch may have a particular composition that may facilitate improved performance and/or manufacturing of the construction material. In an embodiment, the starch can be pregelatinized starch. In an embodiment, the starch may be pretreated with an acid. In an embodiment, the starch may be a dextrin or vegetable flour. In an embodiment, the starch may be wheat flour or a corn flour.

In an embodiment, the construction material may contain a particular starch content that may facilitate improved performance and/or manufacturing of the construction material. In an embodiment, the construction material may include at least 0.001 part starch per 100 parts gypsum or at least 0.01 parts starch or at least 0.1 parts starch or at least 0.2 parts starch or at least 0.3 parts starch or at least 0.4 parts starch or at least 0.5 parts starch or at least 0.6 parts starch or at least 0.7 parts starch or at least 0.8 parts starch or at least 0.9 parts starch. In an embodiment, the construction material may include less than 20 parts starch per 100 parts gypsum or less than 19 parts starch or less than 18 parts starch or less than 17 parts starch or less than 16 parts starch or less than 15 parts starch or less than 14 parts starch or less than 13 parts starch or less than 12 parts starch or less than 11 parts starch or less than 10 parts starch or less than 9 parts starch or less than 8 parts starch or less than 7 parts starch or less than 6 parts starch or less than 5 parts starch or less than 4 parts starch or less than 3 parts starch or less than 2 parts starch or less than 1 part starch. It will be appreciated that the starch content may be within a range between any of the minimum and maximum values noted above. It will be further appreciated that the starch content may be any value between any of the minimum and maximum values noted above.

In an embodiment, the construction material may contain an accelerator. The accelerator may have a particular composition that may facilitate improved performance and/or manufacturing of the construction material. In an embodiment, the accelerator can be a ball milled accelerator. In an embodiment, the accelerator can include ground gypsum.

In an embodiment, the construction material may contain a particular accelerator content that may facilitate improved performance and/or manufacturing of the construction material. In an embodiment, the construction material may include at least 0.1 part accelerator per 100 parts gypsum or at least 0.2 parts accelerator or at least 0.3 parts accelerator or at least 0.4 parts accelerator or at least 0.5 parts accelerator or at least 0.6 parts accelerator or at least 0.7 parts accelerator or at least 0.8 parts accelerator or at least 0.9 parts accelerator. In an embodiment, the construction material may include less than 20 parts accelerator per 100 parts gypsum or less than 19 parts accelerator or less than 18 parts accelerator or less than 17 parts accelerator or less than 16 parts accelerator or less than 15 parts accelerator or less than 14 parts accelerator or less than 13 parts accelerator or less than 12 parts accelerator or less than 11 parts accelerator or less than 10 parts accelerator or less than 9 parts accelerator or less than 8 parts accelerator or less than 7 parts accelerator or less than 6 parts accelerator or less than 5 parts accelerator. It will be appreciated that the accelerator content may be within a range between any of the minimum and maximum values noted above. It will be further appreciated that the accelerator content may be any value between any of the minimum and maximum values noted above.

In an embodiment, the construction material may contain a fire retardant. The fire retardant may have a particular composition that may facilitate improved performance and/or manufacturing of the construction material. In an embodiment, the fire retardant can include vermiculite, silica, clay, metal fibers, mineral fibers, glass fibers, perlite, expandable graphite, or any combination thereof.

In an embodiment, the construction material may contain a particular fire retardant content that may facilitate improved performance and/or manufacturing of the construction material. In an embodiment, the construction material may include at least 0.1 part fire retardant per 100 parts gypsum or at least 0.2 parts fire retardant or at least 0.3 parts fire retardant or at least 0.4 parts fire retardant or at least 0.5 parts fire retardant or at least 0.6 parts fire retardant or at least 0.7 parts fire retardant or at least 0.8 parts fire retardant or at least 0.9 parts fire retardant. In an embodiment, the construction material may include less than 20 parts fire retardant per 100 parts gypsum or less than 19 parts fire retardant or less than 18 parts fire retardant or less than 17 parts fire retardant or less than 16 parts fire retardant or less than 15 parts fire retardant or less than 14 parts fire retardant or less than 13 parts fire retardant or less than 12 parts fire retardant or less than 11 parts fire retardant or less than 10 parts fire retardant or less than 9 parts fire retardant or less than 8 parts fire retardant or less than 7 parts fire retardant or less than 6 parts fire retardant or less than 5 parts fire retardant. It will be appreciated that the fire retardant content may be within a range between any of the minimum and maximum values noted above. It will be further appreciated that the fire retardant content may be any value between any of the minimum and maximum values noted above.

In an embodiment, the construction material may contain water repellant. The water repellant may have a particular composition that may facilitate improved performance and/or manufacturing of the construction material. In an embodiment, the water repellant can include a siloxane or a polysiloxane.

In an embodiment, the construction material may contain a particular water repellant content that may facilitate improved performance and/or manufacturing of the construction material. In an embodiment, the construction material may include at least 0.1 part water repellant per 100 parts gypsum or at least 0.2 parts water repellant or at least 0.3 parts water repellant or at least 0.4 parts water repellant or at least 0.5 parts water repellant or at least 0.6 parts water repellant or at least 0.7 parts water repellant or at least 0.8 parts water repellant or at least 0.9 parts water repellant. In an embodiment, the construction material may include less than 20 parts water repellant per 100 parts gypsum or less than 19 parts water repellant or less than 18 parts water repellant or less than 17 parts water repellant or less than 16 parts water repellant or less than 15 parts water repellant or less than 14 parts water repellant or less than 13 parts water repellant or less than 12 parts water repellant or less than 11 parts water repellant or less than 10 parts water repellant or less than 9 parts water repellant or less than 8 parts water repellant or less than 7 parts water repellant or less than 6 parts water repellant or less than 5 parts water repellant. It will be appreciated that the water repellant content may be within a range between any of the minimum and maximum values noted above. It will be further appreciated that the water repellant content may be any value between any of the minimum and maximum values noted above.

In an embodiment, the construction material may contain a biocide. The biocide may have a particular composition that may facilitate improved performance and/or manufacturing of the construction material. In an embodiment, the biocide can include sodium omadine, a pyrithione, a pyrithione complex, or any combination thereof. In a particular embodiment, the biocide may include a pyrithione or pyrithione complex including ions selected from the group consisting of sodium, zinc, silver, copper, and any combination thereof.

In an embodiment, the construction material may contain a particular biocide content that may facilitate improved performance and/or manufacturing of the construction material. In an embodiment, the construction material may include at least 0.1 part biocide per 100 parts gypsum or at least 0.2 parts biocide or at least 0.3 parts biocide or at least 0.4 parts biocide or at least 0.5 parts biocide or at least 0.6 parts biocide or at least 0.7 parts biocide or at least 0.8 parts biocide or at least 0.9 parts biocide. In an embodiment, the construction material may include less than 20 parts biocide per 100 parts gypsum or less than 19 parts biocide or less than 18 parts biocide or less than 17 parts biocide or less than 16 parts biocide or less than 15 parts biocide or less than 14 parts biocide or less than 13 parts biocide or less than 12 parts biocide or less than 11 parts biocide or less than 10 parts biocide or less than 9 parts biocide or less than 8 parts biocide or less than 7 parts biocide or less than 6 parts biocide or less than 5 parts biocide. It will be appreciated that the biocide content may be within a range between any of the minimum and maximum values noted above. It will be further appreciated that the biocide content may be any value between any of the minimum and maximum values noted above.

In an embodiment, the construction material may contain a fluidizing agent. The fluidizing agent may have a particular composition that may facilitate improved performance and/or manufacturing of the construction material. In an embodiment, the fluidizing agent may be a polycarboxylate ether, a polyphosphonate polyoxyalkylene, or any combination thereof. The construction material may have a particular content of fluidizing agent that may facilitate improved performance and/or manufacturing of the construction material. In an embodiment, the construction material can include less than 1 part fluidizing agent per 100 parts gypsum.

In an embodiment, the construction material may contain a retardant. The retardant may have a particular composition that may facilitate improved performance and/or manufacturing of the construction material. In an embodiment, the retardant may be citric acid and its salts, tartaric acid, sodium polyphosphate, and calcium acetate, or any combination thereof. The construction material may have a particular content of retardant that may facilitate improved performance and/or manufacturing of the construction material. In an embodiment, the construction material can include less than 1 part retardant per 100 parts gypsum.

In an embodiment, the construction material may have a particular nail pull force that may facilitate improved performance and/or manufacturing of the construction material. The nail pull force may be measured according to ASTM C473 Method B. In an embodiment, the nail pull force can be at least 51 lbf or at least 52 lbf or at least 53 lbf or at least 54 lbf or at least 55 lbf. In an embodiment, the nail pull force can be less than 170 lbf or less than 160 lbf or less than 150 lbf or less than 140 lbf or less than 130 lbf or less than 120 lbf or less than 110 lbf or less than 100 lbf or less than 90 lbf or less than 80 lbf or less than 70 lbf or less than 60 lbf. It will be appreciated that the nail pull force may be within a range between any of the minimum and maximum values noted above. It will be further appreciated that the nail pull force may be any value between any of the minimum and maximum values noted above.

In an embodiment, the construction material may have a particular core hardness that may facilitate improved performance and/or manufacturing of the construction material. The core hardness may be measured according to ASTM C473 Method B. In an embodiment, the core hardness can be at least 66 N or at least 67 N or at least 67.5 N or at least 68 N or at least 68.5 N or at least 69 N or at least 69.5 N or at least 70 N or at least 72 N or at least 74 N or at least 76 N or at least 78 N or at least 80 N or at least 82 N or at least 84 N or at least 85 N. In an embodiment, the core hardness can be less than 160 N or less than 150 N or less than 140 N or less than 130 N or less than 120 N or less than 110 N or less than 100 N or less than 90 N or less than 80 N. It will be appreciated that the core hardness may be within a range between any of the minimum and maximum values noted above. It will be further appreciated that the core hardness may be any value between any of the minimum and maximum values noted above.

In an embodiment, the construction material may have a particular median pore size, D50ₚ, that may facilitate improved performance and/or manufacturing of the construction material. In an embodiment, the median pore size, D50ₚ, can be at least 150 microns or at least 200 microns or at least 250 microns or at least 300 microns or at least 350 microns or at least 400 microns. In an embodiment, the D50ₚ, can be less than 1000 microns. It will be appreciated that the D50ₚ may be within a range between any of the minimum and maximum values noted above. It will be further appreciated that the D50ₚ may be any value between any of the minimum and maximum values noted above.

In an embodiment, the construction material may have a particular median pore size, D90ₚ, that may facilitate improved performance and/or manufacturing of the construction material. In an embodiment, the median pore size, D90ₚ, can be at least 750 microns or at least 800 microns or at least 850 microns or at least 900 microns or at least 950 microns or at least 1000 microns or at least 1050 microns or at least 1100 microns or at least 1150 microns or at least 1200 microns. In an embodiment, the D90ₚ, can be less than 10000 microns. It will be appreciated that the D90ₚ may be within a range between any of the minimum and maximum values noted above. It will be further appreciated that the D90ₚ may be any value between any of the minimum and maximum values noted above.

In an embodiment, the construction material may have a particular thickness that may facilitate improved performance and/or manufacturing of the construction material. In an embodiment, the construction material can have a thickness of at least 0.1 inch or at least 0.125 inches or at least 0.25 inches or at least 0.375 inches or at least 0.5 inches or at least 0.675 inches or at least 0.75 inches. In an embodiment, the construction material can have a thickness of less than 1 inch or less than 0.9 inches or less than 0.825 inches or less than 0.75 inches or less than 0.625 inches or less than 0.5 inches. It will be appreciated that the thickness may be within a range between any of the minimum and maximum values noted above. It will be further appreciated that the thickness may be any value between any of the minimum and maximum values noted above.

In an embodiment, the construction material may have a particular density that may facilitate improved performance and/or manufacturing of the construction material. In an embodiment, the density can be at least 1250 lbs/msf or at least 1300 lbs/msf or at least 1350 lbs/msf or at least 1400 lbs/msf or at least 1450 lbs/msf or at least 1500 lbs/msf or at least 1550 lbs/msf or at least 1600 lbs/msf or at least 1650 lbs/msf or at least 1700 lbs/msf or at least 1750 lbs/msf or at least 1800 lbs/msf. In an embodiment, the density can be less than 2550 lbs/msf or less than 2500 lbs/msf or less than 2450 lbs/msf or less than 2400 lbs/msf or less than 2350 lbs/msf or less than 2300 lbs/msf or less than 2250 lbs/msf or less than 2200 lbs/msf or less than 2150 lbs/msf or less than 2100 lbs/msf or less than 2050 lbs/msf or less than 2000 lbs/msf or less than 1950 lbs/msf or less than 1900 lbs/msf. It will be appreciated that the density may be within a range between any of the minimum and maximum values noted above. It will be further appreciated that the density may be any value between any of the minimum and maximum values noted above.

In an embodiment, the construction material may be at least 10 minutes fire rated per ASTM E119 or at least 15 minutes or at least 20 minutes or at least 25 minutes or at least 30 minutes or at least 35 minutes or at least 40 minutes or at least 45 minutes or at least 50 minutes or at least 55 minutes or at least 1-hour fire rated per ASTM E119.

In an embodiment, the construction material may be rated for 30 minutes total water absorption per ASTM C473 Method B or at least 45 minutes or at least 60 minutes or at least 75 minutes or at least 90 minutes or at least 105 minutes or at least 2 hours total water absorption per ASTM C473 Method B.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A plaster based construction material comprising:
a gypsum plaster material; and
at least 1 part by weight biochar per 100 parts by weight gypsum;
wherein the construction material comprises at least one of the following:
a nail pull force according to ASTM C473 Method B of at least 51 lbf;
a core hardness according to ASTM C473 Method B of at least 66 N;
a median pore size, D50ₚ of at least 200 microns; or
a 90^{th} percentile pore size, D90ₚ of at least 750 microns.

Embodiment 2. The construction material of embodiment 1, wherein the construction material has an average nail pull force is at least 51 lbf or at least 52 lbf or at least 53 lbf or at least 54 lbf or at least 55 lbf.

Embodiment 3. The construction material of embodiment 1, wherein the construction material has an average nail pull force is less than 170 lbf or less than 160 lbf or less than 150 lbf or less than 140 lbf or less than 130 lbf or less than 120 lbf or less than 110 lbf or less than 100 lbf or less than 90 lbf or less than 80 lbf or less than 70 lbf or less than 60 lbf.

Embodiment 4. The construction material of embodiment 1, wherein the construction material has a thickness of at least 0.1 inch or at least 0.125 inches or at least 0.25 inches or at least 0.375 inches or at least 0.5 inches or at least 0.675 inches or at least 0.75 inches.

Embodiment 5. The construction material of embodiment 1, wherein the construction material has a thickness of less than 1 inch or less than 0.9 inches or less than 0.825 inches or less than 0.75 inches or less than 0.625 inches or less than 0.5 inches.

Embodiment 6. The construction material of embodiment 1, wherein the construction material has an average core hardness of at least 66 N or at least 67 N or at least 67.5 N or at least 68 N or at least 68.5 N or at least 69 N or at least 69.5 N or at least 70 N or at least 72 N or at least 74 N or at least 76 N or at least 78 N or at least 80 N or at least 82 N or at least 84 N or at least 85 N.

Embodiment 7. The construction material of embodiment 1, wherein the construction material has an average core hardness of less than 160 N or less than 150 N or less than 140 N or less than 130 N or less than 120 N or less than 110 N or less than 100 N or less than 90 N or less than 80 N.

Embodiment 8. The construction material of embodiment 1, wherein the construction material has a D50ₚ of at least 150 microns or at least 200 microns or at least 250 microns or at least 300 microns or at least 350 microns or at least 400 microns.

Embodiment 9. The construction material of embodiment 1, wherein the construction material has a D50ₚ of less than 1000 microns.

Embodiment 10. The construction material of embodiment 1, wherein the construction material has a D90ₚ of at least 750 microns or at least 800 microns or at least 850 microns or at least 900 microns or at least 950 microns or at least 1000 microns or at least 1050 microns or at least 1100 microns or at least 1150 microns or at least 1200 microns.

Embodiment 11. The construction material of embodiment 1, wherein the construction material has a D50ₚ of less than 10000 microns.

Embodiment 12. The construction material of embodiment 1, wherein the construction material has a density of at least 1250 lbs/msf or at least 1300 lbs/msf or at least 1350 lbs/msf or at least 1400 lbs/msf or at least 1450 lbs/msf or at least 1500 lbs/msf or at least 1550 lbs/msf or at least 1600 lbs/msf or at least 1650 lbs/msf or at least 1700 lbs/msf or at least 1750 lbs/msf or at least 1800 lbs/msf.

Embodiment 13. The construction material of embodiment 1, wherein the construction material has a density of less than 2550 lbs/msf or less than 2500 lbs/msf or less than 2450 lbs/msf or less than 2400 lbs/msf or less than 2350 lbs/msf or less than 2300 lbs/msf or less than 2250 lbs/msf or less than 2200 lbs/msf or less than 2150 lbs/msf or less than 2100 lbs/msf or less than 2050 lbs/msf or less than 2000 lbs/msf or less than 1950 lbs/msf or less than 1900 lbs/msf.

Embodiment 14. The construction material of embodiment 1, wherein the construction material comprises at least 1.5 parts biochar per 100 parts by weight gypsum or at least 2 parts biochar or at least 2.5 parts biochar or at least 3 parts biochar or at least 3.5 parts biochar or at least 4 parts biochar or at least 4.5 parts biochar or at least 5 parts biochar.

Embodiment 15. The construction material of embodiment 1, wherein the construction material comprises less than 50 parts biochar per 100 parts by weight gypsum or less than 45 parts biochar or less than 40 parts biochar or less than 35 parts biochar or less than 30 parts biochar or less than 25 parts biochar or less than 20 parts biochar or less than 15 parts biochar.

Embodiment 16. The construction material of embodiment 1, wherein the biochar comprises particles having average size of at least 1 micron or at least 5 microns or at least 10 microns or at least 25 microns or at least 50 microns or at least 100 microns or at least 200 microns or at least 500 microns.

Embodiment 17. The construction material of embodiment 1, wherein the biochar comprises particles having average size of less than 5 mm or less than 4 mm or less than 3 mm or less than 2 mm or less than 1 mm.

Embodiment 18. The construction material of embodiment 1, wherein the biochar is prepared from biomass comprising wood, straw, grass, bagasse, bamboo, herbaceous material, maize, manure, paper sludge, pits, shells, stones, rice and rice residue, sewage, wheat, or any combination thereof.

Embodiment 19. The construction material of embodiment 1, wherein the biochar is prepared via a pyrolysis process of at least 300° C. or at least 325° C. or at least 350° C. or at least 375° C. or at least 400° C. or at least 425° C. or at least 450° C. or at least 475° C. or at least 500° C. or at least 525° C. or at least 550° C. or at least 575° C. or at least 600° C. or at least 625° C. or at least 650° C. or at least 675° C.

Embodiment 20. The construction material of embodiment 1, wherein the biochar is prepared via a pyrolysis process of less than 725° C. or less than 700° C. or less than 675° C. or less than 650° C. or less than 625° C. or less than 600° C. or less than 575° C. or less than 550° C. or less than 525° C. or less than 500° C. or less than 475° C. or less than 450° C. or less than 425° C. or less than 400° C. or less than 375° C.

Embodiment 21. The construction material of embodiment 19 or embodiment 20, wherein the pyrolysis process is anaerobic.

Embodiment 22. The construction material of embodiment 1, further comprising a reinforcer.

Embodiment 23. The construction material of embodiment 22, wherein the reinforcer comprises polymer fibers, mineral fibers, glass fibers, animal fibers, vegetable fibers, or any combination thereof.

Embodiment 24. The construction material of embodiment 22, wherein the reinforcer comprises glass fibers.

Embodiment 25. The construction material of embodiment 22, wherein the construction material comprises at least 0.03 parts reinforcer per 100 parts gypsum or at least 0.05 parts reinforcer or at least 0.1 parts reinforcer or at least 0.2 parts reinforcer or at least 0.3 parts reinforcer or at least 0.4 parts reinforcer or at least 0.5 parts reinforcer or at least 0.6 parts reinforcer or at least 0.7 parts reinforcer or at least 0.8 parts reinforcer or at least 0.9 parts reinforcer.

Embodiment 26. The construction material of embodiment 22, wherein the construction material comprises less than 20 parts reinforcer per 100 parts gypsum or less than 19 parts reinforcer or less than 18 parts reinforcer or less than 17 parts reinforcer or less than 16 parts reinforcer or less than 15 parts reinforcer or less than 14 parts reinforcer or less than 13 parts reinforcer or less than 12 parts reinforcer or less than 11 parts reinforcer or less than 10 parts reinforcer or less than 9 parts reinforcer or less than 8 parts reinforcer or less than 7 parts reinforcer or less than 6 parts reinforcer or less than 5 parts reinforcer.

Embodiment 27. The construction material of embodiment 1, further comprising a starch.

Embodiment 28. The construction material of embodiment 27, wherein the starch comprises a pregelatinized starch.

Embodiment 29. The construction material of embodiment 27, wherein the starch is pretreated with an acid.

Embodiment 30. The construction material of embodiment 27, wherein the starch comprises a dextrin or vegetable flour.

Embodiment 31. The construction material of embodiment 27, wherein the starch comprises wheat flour or corn flour.

Embodiment 32. The construction material of embodiment 27, wherein the construction material comprises at least 0.001 part starch per 100 parts gypsum or at least 0.01 parts starch or at least 0.1 part starch per 100 parts gypsum or at least 0.2 parts starch or at least 0.3 parts starch or at least 0.4 parts starch or at least 0.5 parts starch or at least 0.6 parts starch or at least 0.7 parts starch or at least 0.8 parts starch or at least 0.9 parts starch.

Embodiment 33. The construction material of embodiment 27, wherein the construction material comprises less than 20 parts starch per 100 parts gypsum or less than 19 parts starch or less than 18 parts starch or less than 17 parts starch or less than 16 parts starch or less than 15 parts starch or less than 14 parts starch or less than 13 parts starch or less than 12 parts starch or less than 11 parts starch or less than 10 parts starch or less than 9 parts starch or less than 8 parts starch or less than 7 parts starch or less than 6 parts starch or less than 5 parts starch or less than 4 parts starch or less than 3 parts starch or less than 2 parts starch or less than 1 part starch.

Embodiment 34. The construction material of embodiment 1, further comprising an accelerator.

Embodiment 35. The construction material of embodiment 34, where the accelerator is a ball milled accelerator.

Embodiment 36. The construction material of embodiment 34, wherein the construction material comprises at least 0.1 part accelerator per 100 parts gypsum or at least 0.2 parts accelerator or at least 0.3 parts accelerator or at least 0.4 parts accelerator or at least 0.5 parts accelerator or at least 0.6 parts accelerator or at least 0.7 parts accelerator or at least 0.8 parts accelerator or at least 0.9 parts accelerator.

Embodiment 37. The construction material of embodiment 34, wherein the construction material comprises less than 20 parts accelerator per 100 parts gypsum or less than 19 parts accelerator or less than 18 parts accelerator or less than 17 parts accelerator or less than 16 parts accelerator or less than 15 parts accelerator or less than 14 parts accelerator or less than 13 parts accelerator or less than 12 parts accelerator or less than 11 parts accelerator or less than 10 parts accelerator or less than 9 parts accelerator or less than 8 parts accelerator or less than 7 parts accelerator or less than 6 parts accelerator or less than 5 parts accelerator.

Embodiment 38. The construction material of embodiment 1, further comprising a fluidizing agent.

Embodiment 39. The construction material of embodiment 38, wherein the fluidizing agent comprises a polycarboxylate ether, a polyphosphonate polyoxyalkylene, or any combination thereof.

Embodiment 40. The construction material of embodiment 38, wherein the construction material comprises less than 1 part fluidizing agent per 100 parts gypsum.

Embodiment 41. The construction material of embodiment 1, further comprising a retardant.

Embodiment 42. The construction material of embodiment 41, wherein the retardant comprises citric acid and its salts, tartaric acid, sodium polyphosphate, and calcium acetate, or any combination thereof.

Embodiment 43. The construction material of embodiment 41, wherein the construction material comprises less than 1 part retardant per 100 parts gypsum.

Embodiment 44. The construction material of embodiment 1, further comprising a foaming agent.

Embodiment 45. The construction material of embodiment 44, wherein the foaming agent comprises an allkyl ether sulfate blend or an ammonium salt of a sulfated linear alcohol ethoxylate.

Embodiment 46. The construction material of embodiment 44, wherein the foaming agent comprises sodium lauryl sulfate.

Embodiment 47. The construction material of embodiment 44, wherein the foaming agent comprises an ammonium salt of a sulfated linear alcohol ethoxylate.

Embodiment 48. The construction material of embodiment 44, wherein the construction material comprises at least 0.0001 parts foaming agent per 100 parts gypsum or at least 0.0002 parts foaming agent or at least 0.0003 parts foaming agent or at least 0.0004 parts foaming agent or at least 0.0005 parts foaming agent or at least 0.0006 parts foaming agent or at least 0.0007 parts foaming agent or at least 0.0008 parts foaming agent or at least 0.0009 parts foaming agent.

Embodiment 49. The construction material of embodiment 44, wherein the construction material comprises less than 1 part foaming agent per 100 parts gypsum.

Embodiment 50. The construction material of embodiment 1, further comprising a fire retardant.

Embodiment 51. The construction material of embodiment 50, wherein the fire retardant comprises vermiculite, silica, a clay, metal fibers, mineral fibers, glass fibers, perlite, expandable graphite, or any combination thereof.

Embodiment 52. The construction material of embodiment 50, wherein the construction material comprises at least 0.1 part fire retardant per 100 parts gypsum or at least 0.2 parts fire retardant or at least 0.3 parts fire retardant or at least 0.4 parts fire retardant or at least 0.5 parts fire retardant or at least 0.6 parts fire retardant or at least 0.7 parts fire retardant or at least 0.8 parts fire retardant or at least 0.9 parts fire retardant.

Embodiment 53. The construction material of embodiment 50, wherein the construction material comprises less than 20 parts fire retardant per 100 parts gypsum or less than 19 parts fire retardant or less than 18 parts fire retardant or less than 17 parts fire retardant or less than 16 parts fire retardant or less than 15 parts fire retardant or less than 14 parts fire retardant or less than 13 parts fire retardant or less than 12 parts fire retardant or less than 11 parts fire retardant or less than 10 parts fire retardant or less than 9 parts fire retardant or less than 8 parts fire retardant or less than 7 parts fire retardant or less than 6 parts fire retardant or less than 5 parts fire retardant.

Embodiment 54. The construction material of embodiment 1, further comprising water repellant.

Embodiment 55. The construction material of embodiment 54, wherein the water repellant comprises a siloxane or a polysiloxane.

Embodiment 56. The construction material of embodiment 54, wherein the construction material comprises at least 0.1 part water repellant per 100 parts gypsum or at least 0.2 parts water repellant or at least 0.3 parts water repellant or at least 0.4 parts water repellant or at least 0.5 parts water repellant or at least 0.6 parts water repellant or at least 0.7 parts water repellant or at least 0.8 parts water repellant or at least 0.9 parts water repellant.

Embodiment 57. The construction material of embodiment 54, wherein the construction material comprises less than 20 parts water repellant per 100 parts gypsum or less than 19 parts water repellant or less than 18 parts water repellant or less than 17 parts water repellant or less than 16 parts water repellant or less than 15 parts water repellant or less than 14 parts water repellant or less than 13 parts water repellant or less than 12 parts water repellant or less than 11 parts water repellant or less than 10 parts water repellant or less than 9 parts water repellant or less than 8 parts water repellant or less than 7 parts water repellant or less than 6 parts water repellant or less than 5 parts water repellant.

Embodiment 58. The construction material of embodiment 1, further comprising a biocide.

Embodiment 59. The construction material of embodiment 58, wherein the biocide comprises sodium omadine, a pyrithione, a pyrithione complex, or any combination thereof.

Embodiment 60. The construction material of embodiment 58, wherein the biocide comprises a pyrithione or pyrithione complex comprising ions selected from the group consisting of sodium, zinc, silver, copper, and any combination thereof.

Embodiment 61. The construction material of embodiment 58, wherein the construction material comprises at least 0.1 part biocide per 100 parts gypsum or at least 0.2 parts biocide or at least 0.3 parts biocide or at least 0.4 parts biocide or at least 0.5 parts biocide or at least 0.6 parts biocide or at least 0.7 parts biocide or at least 0.8 parts biocide or at least 0.9 parts biocide.

Embodiment 62. The construction material of embodiment 58, wherein the construction material comprises less than 20 parts biocide per 100 parts gypsum or less than 19 parts biocide or less than 18 parts biocide or less than 17 parts biocide or less than 16 parts biocide or less than 15 parts biocide or less than 14 parts biocide or less than 13 parts biocide or less than 12 parts biocide or less than 11 parts biocide or less than 10 parts biocide or less than 9 parts biocide or less than 8 parts biocide or less than 7 parts biocide or less than 6 parts biocide or less than 5 parts biocide.

Embodiment 63. The construction material of embodiment 1, wherein the construction material is 1-hour fire rated per ASTM E119.

Embodiment 64. The construction material of embodiment 1, wherein the construction material is rated for 2 hours total water absorption per ASTM C473 Method B.

Embodiment 65. A method of forming construction materials comprising:
preparing a mixture comprising stucco, biochar and water;
adding a foaming agent to the mixture;
molding the mixture to form a construction material preform; and
firing the construction material preform to form a construction material.

Embodiment 66. The method of embodiment 65, wherein the mixture comprises at least 40 parts water per 100 parts stucco or at least 42 parts water or at least 44 parts water or at least 46 parts water or at least 48 parts water or at least 50 parts water.

Embodiment 67. The method of embodiment 65, wherein the mixture comprises 80 parts water per 100 parts stucco or less than 78 parts water or less than 76 parts water or less than 74 parts water or less than 72 parts water or less than 70 parts water or less than 68 parts water or less than 66 parts water or less than 64 parts water or less than 62 parts water or less than 60 parts water.

Embodiment 68. The method of embodiment 65, wherein the stucco is gypsum based stucco.

Embodiment 69. The method of embodiment 65, wherein the preform is fired until the preform is essentially free of water.

Embodiment 70. The method of embodiment 65, wherein the mixture comprises at least 1.5 parts biochar per 100 parts by weight stucco or at least 2 parts biochar or at least 2.5 parts biochar or at least 3 parts biochar or at least 3.5 parts biochar or at least 4 parts biochar or at least 4.5 parts biochar or at least 5 parts biochar.

Embodiment 71. The method of embodiment 65, wherein the mixture comprises less than 50 parts biochar per 100 parts by weight stucco or less than 45 parts biochar or less than 40 parts biochar or less than 35 parts biochar or less than 30 parts biochar or less than 25 parts biochar or less than 20 parts biochar or less than 15 parts biochar.

Embodiment 72. The method of embodiment 65, further comprising a reinforcer.

Embodiment 73. The method of embodiment 72, wherein the reinforcer comprises polymer fibers, mineral fibers, glass fibers, animal fibers, vegetable fibers, or any combination thereof.

Embodiment 74. The method of embodiment 72, wherein the reinforcer comprises glass fibers.

Embodiment 75. The method of embodiment 72, wherein the mixture comprises at least 0.03 parts reinforcer per 100 parts stucco or at least 0.05 parts reinforcer or at least 0.1 parts reinforcer or at least 0.2 parts reinforcer or at least 0.3 parts reinforcer or at least 0.4 parts reinforcer or at least 0.5 parts reinforcer or at least 0.6 parts reinforcer or at least 0.7 parts reinforcer or at least 0.8 parts reinforcer or at least 0.9 parts reinforcer.

Embodiment 76. The method of embodiment 72, wherein the mixture comprises less than 20 parts reinforcer per 100 parts stucco or less than 19 parts reinforcer or less than 18 parts reinforcer or less than 17 parts reinforcer or less than 16 parts reinforcer or less than 15 parts reinforcer or less than 14 parts reinforcer or less than 13 parts reinforcer or less than 12 parts reinforcer or less than 11 parts reinforcer or less than 10 parts reinforcer or less than 9 parts reinforcer or less than 8 parts reinforcer or less than 7 parts reinforcer or less than 6 parts reinforcer or less than 5 parts reinforcer.

Embodiment 77. The method of embodiment 65, wherein the mixture further comprises a starch.

Embodiment 78. The method of embodiment 77, wherein the starch comprises pregelatinized starch.

Embodiment 79. The method of embodiment 77, wherein the starch is pretreated with an acid.

Embodiment 80. The method of embodiment 77, wherein the starch comprises a dextrin or vegetable flour.

Embodiment 81. The method of embodiment 77, wherein the starch comprises wheat flour or corn flour.

Embodiment 82. The method of embodiment 77, wherein the mixture comprises at least 0.001 part starch per 100 parts stucco or at least 0.01 parts starch or at least 0.1 parts starch or at least 0.2 parts starch or at least 0.3 parts starch or at least 0.4 parts starch or at least 0.5 parts starch or at least 0.6 parts starch or at least 0.7 parts starch or at least 0.8 parts starch or at least 0.9 parts starch.

Embodiment 83. The method of embodiment 77, wherein the mixture comprises less than 20 parts starch per 100 parts stucco or less than 19 parts starch or less than 18 parts starch or less than 17 parts starch or less than 16 parts starch or less than 15 parts starch or less than 14 parts starch or less than 13 parts starch or less than 12 parts starch or less than 11 parts starch or less than 10 parts starch or less than 9 parts starch or less than 8 parts starch or less than 7 parts starch or less than 6 parts starch or less than 5 parts starch or less than 4 parts starch or less than 3 parts starch or less than 2 parts starch or less than 1 part starch.

Embodiment 84. The method of embodiment 65, wherein the mixture further comprises an accelerator.

Embodiment 85. The method of embodiment 84, where the accelerator is a ball milled accelerator.

Embodiment 86. The method of embodiment 84, wherein the mixture comprises at least 0.1 part accelerator per 100 parts stucco or at least 0.2 parts accelerator or at least 0.3 parts accelerator or at least 0.4 parts accelerator or at least 0.5 parts accelerator or at least 0.6 parts accelerator or at least 0.7 parts accelerator or at least 0.8 parts accelerator or at least 0.9 parts accelerator.

Embodiment 87. The method of embodiment 84, wherein the mixture comprises less than 20 parts accelerator per 100 parts stucco or less than 19 parts accelerator or less than 18 parts accelerator or less than 17 parts accelerator or less than 16 parts accelerator or less than 15 parts accelerator or less than 14 parts accelerator or less than 13 parts accelerator or less than 12 parts accelerator or less than 11 parts accelerator or less than 10 parts accelerator or less than 9 parts accelerator or less than 8 parts accelerator or less than 7 parts accelerator or less than 6 parts accelerator or less than 5 parts accelerator.

Embodiment 88. The method of embodiment 65, wherein the mixture comprises a fluidizing agent.

Embodiment 89. The method of embodiment 88, wherein the mixture comprises a polycarboxylate ether, a polyphosphonate polyoxyalkylene, or any combination thereof.

Embodiment 90. The method of embodiment 88, wherein the mixture comprises less than 1 part fluidizing agent per 100 parts stucco.

Embodiment 91. The method of embodiment 65, wherein the mixture comprises a retardant.

Embodiment 92. The method of embodiment 91, wherein the retardant comprises citric acid and its salts, tartaric acid, sodium polyphosphate, and calcium acetate, or any combination thereof.

Embodiment 93. The method of embodiment 91, wherein the mixture comprises less than 1 part retardant per 100 parts stucco.

Embodiment 94. The method of embodiment 65, wherein the foaming agent comprises an alkyl ether sulfate blend or an ammonium salt of a sulfated linear alcohol ethoxylate.

Embodiment 95. The method of embodiment 65, wherein the foaming agent comprises sodium lauryl sulfate.

Embodiment 96. The method of embodiment 65, wherein the foaming agent comprises an ammonium salt of a sulfated linear alcohol ethoxylate.

Embodiment 97. The method of embodiment 65, wherein the mixture comprises at least 0.0001 parts foaming agent per 100 parts stucco or at least 0.0002 parts foaming agent or at least 0.0003 parts foaming agent or at least 0.0004 parts foaming agent or at least 0.0005 parts foaming agent or at least 0.0006 parts foaming agent or at least 0.0007 parts foaming agent or at least 0.0008 parts foaming agent or at least 0.0009 parts foaming agent.

Embodiment 98. The method of embodiment 65, wherein the mixture comprises less than 1 part foaming agent per 100 parts stucco.

Embodiment 99. The method of embodiment 65, wherein the mixture comprises a fire retardant.

Embodiment 100. The method of embodiment 99, wherein the fire retardant comprises vermiculite, silica, a clay, metal fibers, mineral fibers, glass fibers, perlite, expandable graphite, or any combination thereof.

Embodiment 101. The method of embodiment 99, wherein the mixture comprises at least 0.1 part fire retardant per 100 parts stucco or at least 0.2 parts fire retardant or at least 0.3 parts fire retardant or at least 0.4 parts fire retardant or at least 0.5 parts fire retardant or at least 0.6 parts fire retardant or at least 0.7 parts fire retardant or at least 0.8 parts fire retardant or at least 0.9 parts fire retardant.

Embodiment 102. The method of embodiment 99, wherein the mixture comprises less than 20 parts fire retardant per 100 parts stucco or less than 19 parts fire retardant or less than 18 parts fire retardant or less than 17 parts fire retardant or less than 16 parts fire retardant or less than 15 parts fire retardant or less than 14 parts fire retardant or less than 13 parts fire retardant or less than 12 parts fire retardant or less than 11 parts fire retardant or less than 10 parts fire retardant or less than 9 parts fire retardant or less than 8 parts fire retardant or less than 7 parts fire retardant or less than 6 parts fire retardant or less than 5 parts fire retardant.

Embodiment 103. The method of embodiment 65, further comprising water repellant.

Embodiment 104. The method of embodiment 103, wherein the water repellant comprises a siloxane or a polysiloxane.

Embodiment 105. The method of embodiment 103, wherein the mixture comprises at least 0.1 part water repellant per 100 parts stucco or at least 0.2 parts water repellant or at least 0.3 parts water repellant or at least 0.4 parts water repellant or at least 0.5 parts water repellant or at least 0.6 parts water repellant or at least 0.7 parts water repellant or at least 0.8 parts water repellant or at least 0.9 parts water repellant.

Embodiment 106. The method of embodiment 103, wherein the mixture comprises less than 20 parts water repellant per 100 parts stucco or less than 19 parts water repellant or less than 18 parts water repellant or less than 17 parts water repellant or less than 16 parts water repellant or less than 15 parts water repellant or less than 14 parts water repellant or less than 13 parts water repellant or less than 12 parts water repellant or less than 11 parts water repellant or less than 10 parts water repellant or less than 9 parts water repellant or less than 8 parts water repellant or less than 7 parts water repellant or less than 6 parts water repellant or less than 5 parts water repellant.

Embodiment 107. The method of embodiment 65, further comprising a biocide.

Embodiment 108. The method of embodiment 107, wherein the biocide comprises sodium omadine, a pyrithione, a pyrithione complex, or any combination thereof.

Embodiment 109. The method of embodiment 107, wherein the biocide comprises a pyrithione or pyrithione complex comprising ions selected from the group consisting of sodium, zinc, silver, copper, and any combination thereof.

Embodiment 110. The method of embodiment 107, wherein the mixture comprises at least 0.1 part biocide per 100 parts stucco or at least 0.2 parts biocide or at least 0.3 parts biocide or at least 0.4 parts biocide or at least 0.5 parts biocide or at least 0.6 parts biocide or at least 0.7 parts biocide or at least 0.8 parts biocide or at least 0.9 parts biocide.

Embodiment 111. The method of embodiment 107, wherein the mixture comprises less than 20 parts biocide per 100 parts stucco or less than 19 parts biocide or less than 18 parts biocide or less than 17 parts biocide or less than 16 parts biocide or less than 15 parts biocide or less than 14 parts biocide or less than 13 parts biocide or less than 12 parts biocide or less than 11 parts biocide or less than 10 parts biocide or less than 9 parts biocide or less than 8 parts biocide or less than 7 parts biocide or less than 6 parts biocide or less than 5 parts biocide.

### EXAMPLES

### Example 1—Nail Pull Resistance

Samples S1, S2, as well as control sample C1 were prepared according to the following process and the composition according to table 1 below. Biochar powder was prepared from biochar pellets via mortar and pestle until all biochar were particles having a size of below 1 mm diameter. Biochar pellets were prepared by Skyclean company from a straw pellet feedstock. Dry ingredients including gypsum based stucco (calcium sulfate hemihydrate), starch (S23F from Grain Processing Corporation), an accelerator (ground gypsum from CertainTeed) were mixed in a steel bowl. In another bowl, tap water along with fluidizer (Disal from Ruetgers Polymers Ltd) and a 1% retardant (Plast retard L from SICIT 2000 S.p.A.) solution in deionized water. Weights for the retardant listing in table 1 include only the retardant weight and not the weight of the water. The liquid and dry ingredients were mixed together with a high shear mixer at 2750 RPM for 35 s. Foam (PFM33 from Geochemicals) was then injected into the mixture to produce the target board weight according to table 1. The stucco slurry was then immediately poured into a premade paper envelope (paper weight: 44 lbs/msf) to shape the slurry into a board having thickness ⅝″. The gypsum was allowed to set. The boards were placed into an oven preset at 180° C. for 35 minutes with water tray to limit overburn of the plaster and then transferred to another oven preset at 40° C. to finalize drying until constant weight.

TABLE 1

| Component | C1 | | | S1 | | | S2 | | |
|---|---|---|---|---|---|---|---|---|---|
| Target | 1850 Lbs/msf | | | 1850 Lbs/msf | | | 1850 Lbs/msf | | |
| Density | | | | | | | | | |
| Thickness | 5/8″ | | | 5/8″ | | | 5/8″ | | |
| | | | Wt % | | | Wt % | | | Wt % |
| | Wt | Wt % | (% of | Wt | Wt % | (% of | Wt | Wt % | (% of |
| | (g) | (total) | stucco) | (g) | (total) | stucco) | (g) | (total) | stucco) |
| Stucco | 475-525 | 55-65 | | 475-525 | 55-65 | | 475-525 | 55-65 | |
| Tap Water | 275-285 | 30-40 | | 275-285 | 30-40 | | 275-285 | 30-40 | |
| Accelerator | 1-3 | <0.5 | 0.2-0.6 | 1-3 | <0.5 | 0.2-0.6 | 1-3 | <0.5 | 0.2-0.6 |
| Fluidizer | 0 | 0 | 0 | 1 | <0.5 | 0.1-0.3 | 1.6 | <0.5 | 0.1-0.3 |
| Retardant | 0.2-0.3 | <0.1 | <0.1 | 0.2-0.3 | <0.1 | <0.1 | 0.2-0.3 | <0.1 | <0.1 |
| Starch | 3-7 | 0.1-1 | 0.5-2 | 3-7 | 0.1-1 | 0.5-2 | 3-7 | 0.1-1 | 0.5-2 |
| Biochar | 0 | 0 | 0 | 25 | 2-4 | 4-6 | 50 | 5-7 | 9-11 |
| Foam density | 99.9 | | | 99.9 | | | 99.9 | | |
| (g/L) | | | | | | | | | |
| Foam mass | 212.8 | | | 212.8 | | | 212.8 | | |
| rate (g/min) | | | | | | | | | |

| | | | |
|---|---|---|---|
| Foam time (s) | 16.6 | 16.6 | 16.6 |

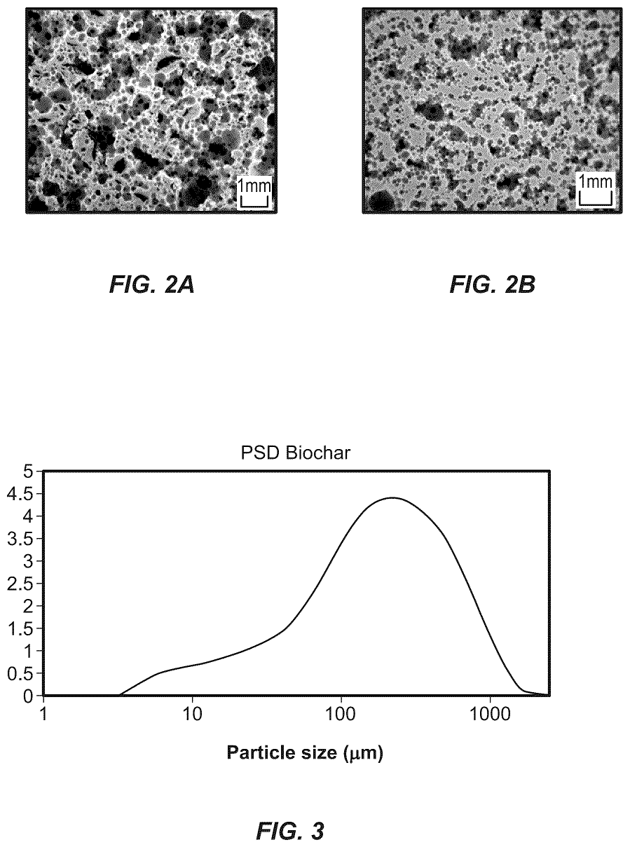

Each sample plaster board was tested in 5 locations for nail pull resistance according to ASTM C473 Method B. Core hardness and nail pull resistance results may be found below in table 2. Magnified images of cross-sections S2 and C1 and be found in FIGS. 2a and 2b, respectively.

TABLE 2

| Sample | Average Nail Pull (lbf) |
|---|---|
| C1 | 49.4 |
| S1 | 57.8 |
| S2 | 55.2 |

### Example 2—Core Hardness

Sample S3, control sample C2, and comparative sample CS1 including charcoal (Jealous Devil Chunx) instead of biochar were prepared according to the procedure above having the compositions detailed below in table 3. For these samples, the procedure was modified such that the biochar pellets were crushed via blender instead of mortar and pestle. The resulting biochar particle size distribution may be found in FIG. 3.

TABLE 3

| Component | C2 | | | S3 | | | CS1 | | |
|---|---|---|---|---|---|---|---|---|---|
| Target | 1850 Lbs/msf | | | 1850 Lbs/msf | | | 1850 Lbs/msf | | |
| Density | | | | | | | | | |
| Thickness | 5/8″ | | | 5/8″ | | | 5/8″ | | |
| | | | Wt % | | | Wt % | | | Wt % |
| | Wt | Wt | (% of | Wt | Wt | (% of | Wt | Wt | (% of |
| | (g) | % | stucco) | (g) | % | stucco) | (g) | % | stucco) |
| Stucco | 475-525 | 55-65 | | 475-525 | 55-65 | | 475-525 | 55-65 | |
| Tap Water | 275-285 | 30-40 | | 275-285 | 30-40 | | 275-285 | 30-40 | |
| Accelerator | 1-3 | <0.5 | 0.2-0.6 | 1-3 | <0.5 | 0.2-0.6 | 1-3 | <0.5 | 0.2-0.6 |
| Fluidizer | 0 | 0 | 0 | 1 | <0.5 | 0.1-0.3 | 1 | <0.5 | 0.1-0.3 |
| Retardant | 0.2-0.3 | <0.1 | <0.1 | 0.2-0.3 | <0.1 | <0.1 | 0.2-0.3 | <0.1 | <0.1 |
| Starch | 3-7 | 0.1-1 | 0.5-2 | 3-7 | 0.1-1 | 0.5-2 | 3-7 | 0.1-1 | 0.5-2 |
| Biochar | 0 | 0 | 0 | 25 | 2-4 | 4-6 | 0 | 0 | 0 |
| Charcoal | 0 | 0 | 0 | 0 | 0 | 0 | 25 | 2-4 | 4-6 |
| Foam density | 99.4 | | | 99.4 | | | 99.4 | | |
| (g/L) | | | | | | | | | |
| Foam mass | 203.8 | | | 203.8 | | | 203.8 | | |
| rate (g/min) | | | | | | | | | |

| | | | |
|---|---|---|---|
| Foam time (s) | 17.2 | 17.2 | 17.2 |

Each plaster board was tested for core hardness in 8 locations according to ASTM C473 Method B. Core hardness results may be found below in table 4.

TABLE 4

| Sample | Average Core hardness (N) |
|---|---|
| C2 | 66.44 |
| S3 | 70.48 |
| CS1 | 65.79 |

### Example 3—Biochar+Surfactants

Samples S4, S5, as well as control samples C3 and C4 were prepared according to the following process and the composition according to table 5 below. Dry ingredients including gypsum based stucco (calcium sulfate hemihydrate), starch (S23F from Grain Processing Corporation), an accelerator (ground gypsum from CertainTeed) were mixed in a steel bowl. In another bowl, tap water along with fluidizer (Disal from Ruetgers Polymers Ltd) and a 1% retardant (Plast retard L from SICIT 2000 S.p.A.) solution in deionized water. Weights for the retardant listing in table 1 include only the retardant weight and not the weight of the water. The liquid and dry ingredients were mixed together with a high shear mixer at 2750 RPM for 35 s. Foam was then injected into the mixture to produce the target board weight according to table 5. Samples C3 and S4 used PFM 33 as a foaming agent while C4 and S5 used GFA-05. The stucco slurry was then immediately poured into a premade paper envelope (paper weight: 44 lbs/msf) to shape the slurry into a board having thickness ⅝″. The gypsum was allowed to set. The boards were placed into an oven preset at 180° C. for 35 minutes with water tray to limit overburn of the plaster and then transferred to another oven preset at 40° C. to finalize drying until constant weight.

TABLE 5

| Component | C3 | | | S4 | | |
|---|---|---|---|---|---|---|
| Target | 1850 Lbs/msf | | | 1850 Lbs/msf | | |
| Density | | | | | | |
| Thickness | 5/8″ | | | 5/8″ | | |
| | | | Wt % | | | Wt % |
| | Wt | Wt | (% of | Wt | Wt | (% of |
| | (g) | % | stucco) | (g) | % | stucco) |
| Stucco | 475-525 | 55-65 | | 475-525 | 55-65 | |
| Tap Water | 275-285 | 30-40 | | 275-285 | 30-40 | |
| Accelerator | 1-3 | <0.5 | 0.2-0.6 | 1-3 | <0.5 | 0.2-0.6 |
| Fluidizer | 0.2-0.5 | <0.1 | <0.1 | 0.2-0.5 | <0.1 | <0.1 |
| Retardant | 23 | <0.1 | <0.1 | 23 | <0.1 | <0.1 |
| Starch | 3-7 | 0.1-1 | 0.5-2 | 3-7 | 0.1-1 | 0.5-2 |
| Biochar | 0 | 0 | 0 | 50 | 5-8 | 10 |
| Foam density | 99.3 | | | 99.3 | | |
| (g/L) | | | | | | |
| Foam mass | 190 | | | 190 | | |
| rate (g/min) | | | | | | |
| Foam time (s) | 18.22 | | | 18.22 | | |
| Component | C4 | | | S5 | | |
| Target | 1850 Lbs/msf | | | 1850 Lbs/msf | | |
| Density | | | | | | |
| Thickness | 5/8″ | | | 5/8″ | | |
| | | | Wt % | | | Wt % |
| | Wt | Wt | (% of | Wt | Wt | (% of |
| | (g) | % | stucco) | (g) | % | stucco) |
| Stucco | 475-525 | 55-65 | | 475-525 | 55-65 | |
| Tap Water | 275-285 | 30-40 | | 275-285 | 30-40 | |
| Accelerator | 1-3 | <0.5 | 0.2-0.6 | 1-3 | <0.5 | 0.2-0.6 |
| Fluidizer | 0.2-0.5 | <0.1 | <0.1 | 0.9-1.1 | <0.1 | <0.1 |
| Retardant | 23 | <0.1 | <0.1 | 19 | <0.1 | <0.1 |
| Starch | 3-7 | 0.1-1 | 0.5-2 | 3-7 | 0.1-1 | 0.5-2 |
| Biochar | 0 | 0 | 0 | 50 | 5-8 | 10 |
| Foam density | 99.3 | | | 115 | | |
| (g/L) | | | | | | |
| Foam mass | 190 | | | 232 | | |
| rate (g/min) | | | | | | |

| | | |
|---|---|---|
| Foam time (s) | 18.22 | 17.59 |

Each plaster board was tested for core hardness in 8 locations according to ASTM C473 Method B. Core hardness results may be found below in table 6. Samples were also evaluated for foamed pore size. Pore size is determined via photo analysis of the core of the board. Samples were cut using a router table to ensure the edges are smooth, the section is then blown with compressed air to remove any dust particles that may be lodged within the pores. Photos were taken of the core and imported into image analysis software such as ImageJ used to determine a pore size distribution.

TABLE 6

| | Average Normalized | Std. | | | |
|---|---|---|---|---|---|
| Sample | Max Force | Error | d10 | d50 | d90 |
| C3 | 60.24 | 3.38 | 114.8 | 147.7 | 593.5 |
| S4 | 74.75 | 10.28 | 97.7 | 128.0 | 767.2 |
| C4 | 62.96 | 3.06 | 109.7 | 140.2 | 734.5 |
| S5 | 91.95 | 9.48 | 114.9 | 432.1 | 1257.8 |

What is claimed is:

1. A plaster based construction material comprising:
a gypsum plaster material; and
at least 1 part by weight biochar per 100 parts by weight gypsum;
wherein the construction material comprises at least one of the following:
a nail pull force according to ASTM C473 Method B of at least 51 lbf;
a core hardness according to ASTM C473 Method B of at least 66 N;
a median pore size, D50ₚ of at least 200 microns; or
a 90^{th} percentile pore size, D90ₚ of at least 750 microns.

2. The construction material of claim 1, wherein the construction material has an average nail pull force is at least 51 lbf or at least 52 lbf or at least 53 lbf or at least 54 lbf or at least 55 lbf.

3. The construction material of claim 1, wherein the construction material has an average nail pull force is less than 170 lbf or less than 160 lbf or less than 150 lbf or less than 140 lbf or less than 130 lbf or less than 120 lbf or less than 110 lbf or less than 100 lbf or less than 90 lbf or less than 80 lbf or less than 70 lbf or less than 60 lbf.

4. The construction material of claim 1, wherein the construction material has an average core hardness of at least 66 N or at least 67 N or at least 67.5 N or at least 68 N or at least 68.5 N or at least 69 N or at least 69.5 N or at least 70 N or at least 72 N or at least 74 N or at least 76 N or at least 78 N or at least 80 N or at least 82 N or at least 84 N or at least 85 N.

5. The construction material of claim 1, wherein the construction material has an average core hardness of less than 160 N or less than 150 N or less than 140 N or less than 130 N or less than 120 N or less than 110 N or less than 100 N or less than 90 N or less than 80 N.

6. The construction material of claim 1, wherein the construction material has a D50ₚ of at least 150 microns or at least 200 microns or at least 250 microns or at least 300 microns or at least 350 microns or at least 400 microns.

7. The construction material of claim 1, wherein the construction material has a D50ₚ of less than 1000 microns.

8. The construction material of claim 1, wherein the construction material has a D90ₚ of at least 750 microns or at least 800 microns or at least 850 microns or at least 900 microns or at least 950 microns or at least 1000 microns or at least 1050 microns or at least 1100 microns or at least 1150 microns or at least 1200 microns.

9. The construction material of claim 1, wherein the construction material has a D50ₚ of less than 10000 microns.

10. The construction material of claim 1, further comprising a foaming agent.

11. The construction material of claim 10, wherein the foaming agent comprises an alkyl ether sulfate blend or an ammonium salt of a sulfated linear alcohol ethoxylate.

12. The construction material of claim 10, wherein the foaming agent comprises sodium lauryl sulfate.

13. The construction material of claim 10, wherein the foaming agent comprises an ammonium salt of a sulfated linear alcohol ethoxylate.

14. The construction material of claim 1, wherein the construction material is 1-hour fire rated per ASTM E119.

15. The construction material of claim 1, wherein the construction material is rated for 2 hours total water absorption per ASTM C473 Method B.

16. A method of forming construction materials comprising:
preparing a mixture comprising stucco, biochar and water;
adding a foaming agent to the mixture;
molding the mixture to form a construction material preform; and
firing the construction material preform to form a construction material.

17. The method of claim 16, wherein the preform is fired until the preform is essentially free of water.

18. The method of claim 16, wherein the foaming agent comprises an alkyl ether sulfate blend or an ammonium salt of a sulfated linear alcohol ethoxylate.

19. The method of claim 16, wherein the foaming agent comprises sodium lauryl sulfate.

20. The method of claim 16, wherein the foaming agent comprises an ammonium salt of a sulfated linear alcohol ethoxylate.
